(19) United States
(12) Patent Application Publication
(10) Pub. No.: US 2008/0171255 A1
(43) Pub. Date: Jul. 17, 2008

(54) FUEL CELL FOR USE IN A PORTABLE FUEL CELL SYSTEM

(75) Inventors: Jennifer Brantley, Dublin, CA (US); Gerry Tucker, Pleasanton, CA (US)

Correspondence Address: BEYER WEAVER LLP, P.O. BOX 70250, OAKLAND, CA, 94612-0250, US

(73) Assignee: ULTRACELL CORPORATION, Livermore, CA (US)

(21) Appl. No.: 11/834,592

(22) Filed: Aug. 6, 2007

Related U.S. Application Data
(60) Provisional application No. 60/836,827, filed on Aug. 9, 2006.

(51) Int. Cl. H01M 2/00; H01M 6/00

(52) U.S. Cl. 429/34; 29/623.1

(57) ABSTRACT

In one embodiment, a fuel cell stack for use in a fuel cell comprises a plurality of cathode flow field plates having a first plurality of through-cuts to form a first plurality of shared flow fields to receive a first reactant gas flow, a plurality of anode flow field plates having a second plurality of through-cuts to form a second plurality of shared flow fields to receive a second reactant gas flow, and a plurality of MEA layers, each MEA layer disposed between one of the plurality of cathode flow field plates and one of the plurality of anode flow field plates, each of the MEA layers including an anode electrode a cathode electrode, wherein adjacent cathode electrodes of adjacent MEA layers share the first plurality of shared flow fields, and wherein adjacent anode electrodes of adjacent MEA layers share the second plurality of shared flow fields.

### CROSS REFERENCE TO RELATED APPLICATIONS

This application claims priority under 35 U.S.C. §119(e) to U.S. Provisional Patent Application No. 60/836,827 filed on Aug. 9, 2006 entitled “Fuel Cell For Use In A Portable Fuel Cell System”, which is incorporated by reference herein for all purposes.

### FIELD OF THE INVENTION

The present disclosure relates generally to fuel cell technology. In particular, the invention relates to fuel cells, used in a fuel cell system, to convert hydrogen to electrical energy.

### BACKGROUND OF THE INVENTION

A fuel cell electrochemically combines hydrogen and oxygen to generate electrical energy. Fuel cell development so far has only serviced large-scale applications such as industrial size generators for electrical power back up. Consumer electronics devices and other portable electrical power applications currently rely on lithium ion and similar battery technologies. Fuel cell systems that generate electrical energy for portable applications such as electronics would be desirable. In addition, technology advances that reduce fuel cell system size would be beneficial.

### OVERVIEW

The invention provides for an example fuel cell for use in a fuel cell system. The fuel cell stack may have a flow field plate having a plurality of through-cut openings forming shared flow fields. The shared flow fields allow for the same reactant gases to be used between adjacent MEA layers on the top and bottom surface of the flow field plate. In one embodiment, a fuel cell stack for use in a fuel cell may comprise a plurality of cathode flow field plates having a first plurality of through-cuts to form a first plurality of shared flow fields to receive a first reactant gas flow, a plurality of anode flow field plates having a second plurality of through-cuts to form a second plurality of shared flow fields to receive a second reactant gas flow, and a plurality of membrane electrode assembly (MEA) layers, each MEA layer disposed between one of the plurality of cathode flow field plates and one of the plurality of anode flow field plates, each of the MEA layers including an anode electrode a cathode electrode, wherein adjacent cathode electrodes of adjacent MEA layers share the first plurality of shared flow fields, and wherein adjacent anode electrodes of adjacent MEA layers share the second plurality of shared flow fields.

In another embodiment, the fuel cell stack may have a first MEA layer including a first anode electrode and a first cathode electrode, a second MEA layer including a second anode electrode and a second cathode electrode. An anode flow field plate may be disposed between the first MEA layer and the second MEA layer, the anode flow field plate having a plurality of through-cuts to form a plurality of shared anode flow fields to receive a first reactant gas flow, wherein the first anode electrode and the second anode electrode receive the first reactant gas flow from the plurality of shared anode flow fields. A third MEA layer may include a third anode electrode and a third cathode electrode. A cathode flow field plate may be disposed between the second MEA layer and the third MEA layer, the cathode flow field plate having a plurality of through-cuts to form a plurality of shared cathode flow fields to receive a second reactant gas flow, wherein the second cathode electrode and the third cathode electrode receive the second reactant gas flow from the plurality of shared cathode flow fields.

In yet another embodiment, a method for manufacturing a fuel cell stack, comprises, forming a plurality of through-cut cathode openings on a first pair of cathode conductive plates, forming a plurality of through-cut openings on a first dielectric plate, forming a plurality of through-cut anode openings on a first pair of anode conductive plates, and forming a plurality of through-cut openings on a second dielectric plate. The method further comprises joining the first dielectric plate between the first pair of cathode conductive plates to form a first cathode flow field plate, wherein the plurality of through-cut openings on the first dielectric plate align with the plurality of through-cut cathode openings, joining the second dielectric plate between the first pair of anode conductive plates to form a first anode flow field plate, wherein the plurality of through-cut openings on the second dielectric plate align with the plurality of through-cut anode openings, coupling a first end of a first current connector to a first side of the first cathode flow field plate and a second end of the first current connector to a first side of the first anode flow field plate, and inserting a first membrane electrode layer (MEA) between the first cathode flow field plate and the first anode flow field plate, wherein the first cathode flow field plate is adjacent a cathode electrode of the MEA such that the cathode electrodes of adjacent MEAs share the through-cut cathode openings, and wherein the first anode flow field plate is adjacent the anode electrode of the MEA such that anode electrodes of adjacent MEAs share the anode through-cut anode openings.

These and other features will be presented in more detail in the following detailed description of the invention and the associated figures.

### BRIEF DESCRIPTION OF THE DRAWINGS

The accompanying drawings, which are incorporated into and constitute a part of this specification, illustrate one or more example embodiments and, together with the description of example embodiments, serve to explain the principles and implementations.

In the drawings:

FIGS. 1A and 1B illustrate an exemplary fuel cell stack and fuel cell.

FIGS. 2A, 2B, 2C, and 2D illustrate an exemplary flow field plate used in a fuel cell.

FIGS. 3A and 3B illustrate a flow chart of an example method for manufacturing a fuel cell.

FIG. 4 illustrates an example membrane electrode assembly (MEA).

FIGS. 5A, 5B, and 5C illustrate exemplary fuel cell stacks.

FIGS. 6A and 6B illustrate an example fuel cell package and a schematic operation of the fuel cell package.

### DESCRIPTION OF EXAMPLE EMBODIMENTS

Embodiments are described herein in the context of a fuel cell for use in a portable fuel cell system. The following detailed description is illustrative only and is not intended to be in any way limiting. Other embodiments will readily suggest themselves to such skilled persons having the benefit of this disclosure. Reference will now be made in detail to implementations as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Exemplary Fuel Cell

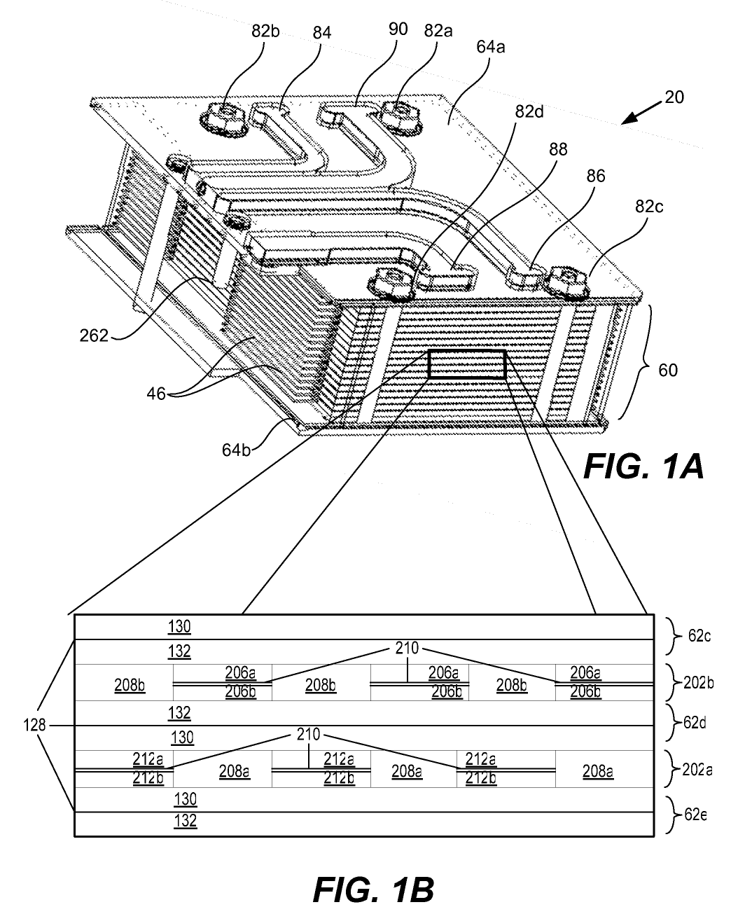

FIGS. 1A and 1B illustrate an exemplary fuel cell stack and fuel cell. Referring to FIG. 1A, a top perspective view of the fuel cell stack 60 and fuel cell 20, the fuel cell 20 may have top and bottom end plates 64a and 64b to provide mechanical protection for stack 60. End plates 64 also hold the flow field plate 202 and membrane electrode assembly (MEA) layers 62 together and apply pressure across the planar area of each flow field plates 202 and each MEA 62 (FIG. 1B). End plates 64 may include steel or another suitably stiff material. Bolts 82a-d connect and secure top and bottom end plates 64a and 64b together.

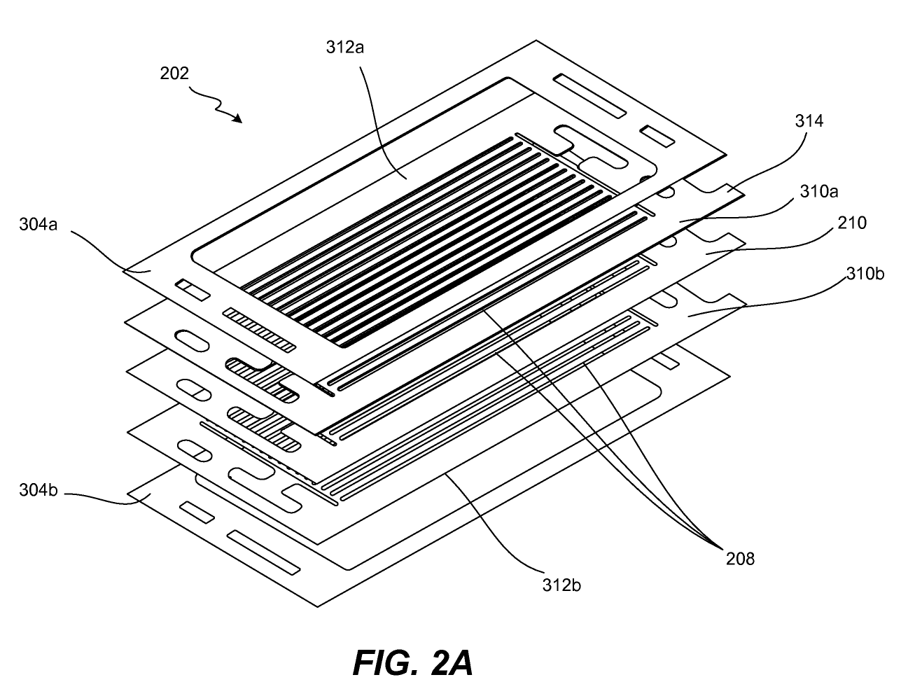

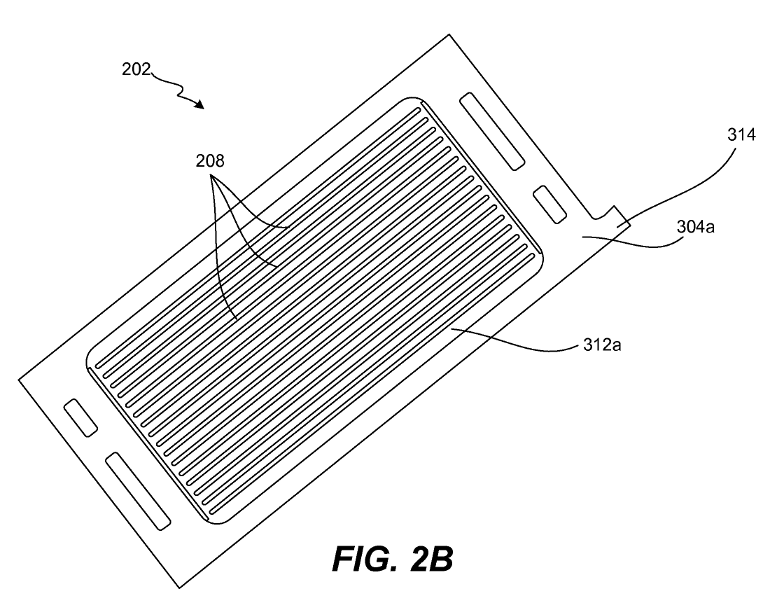

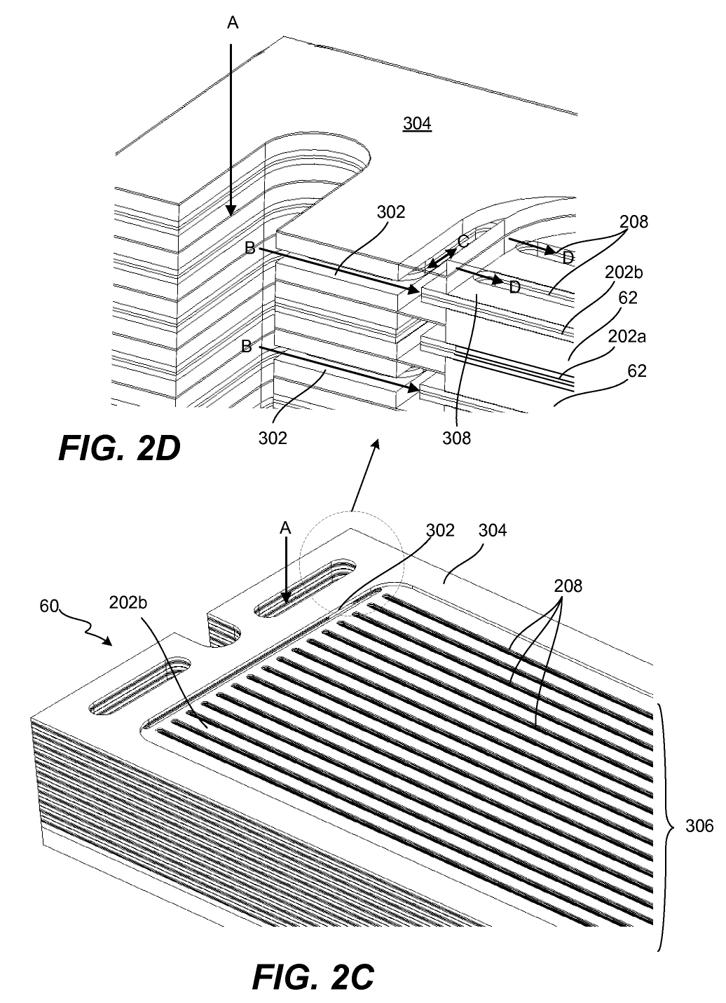

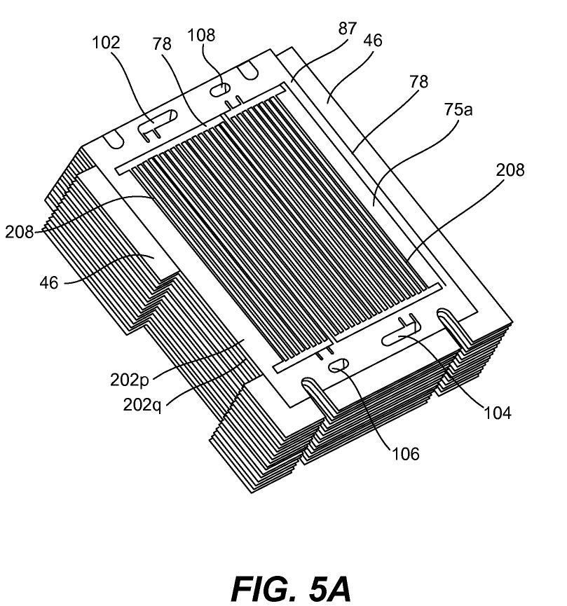

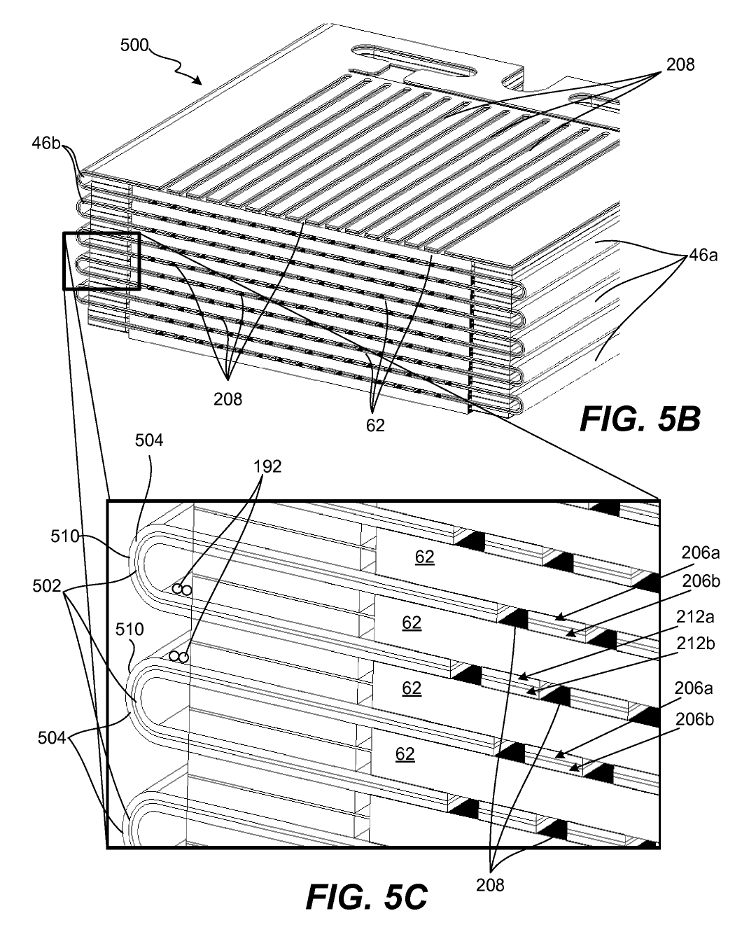

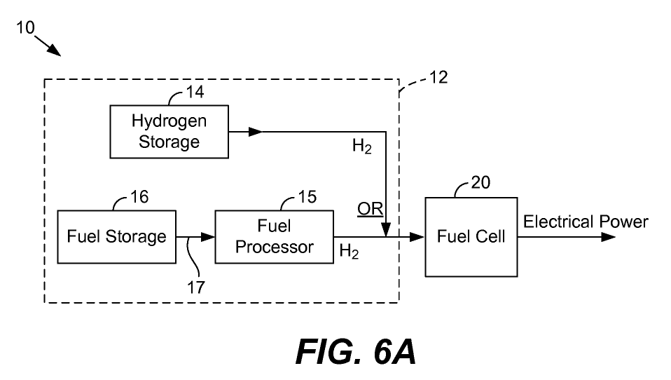

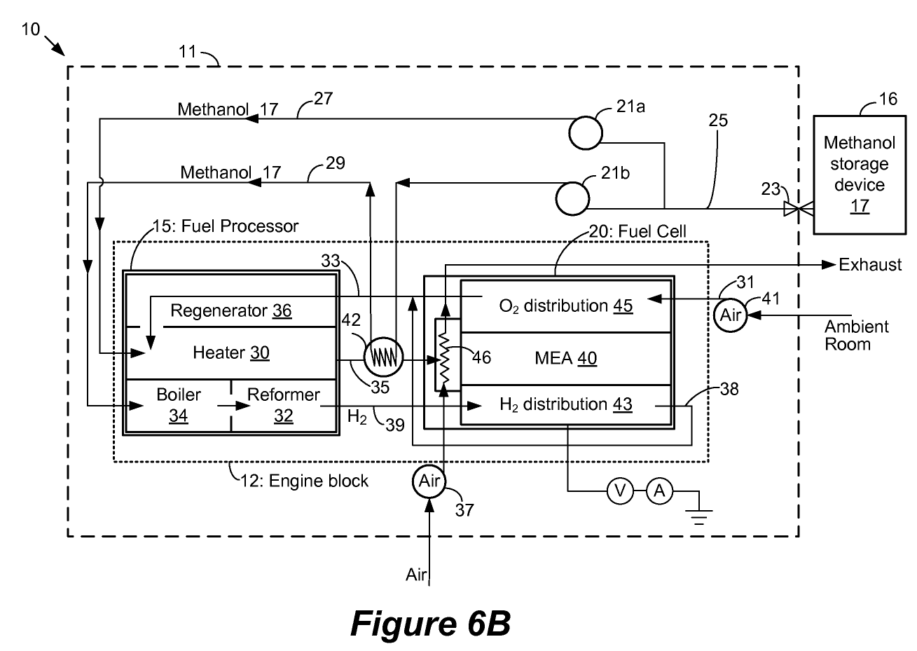

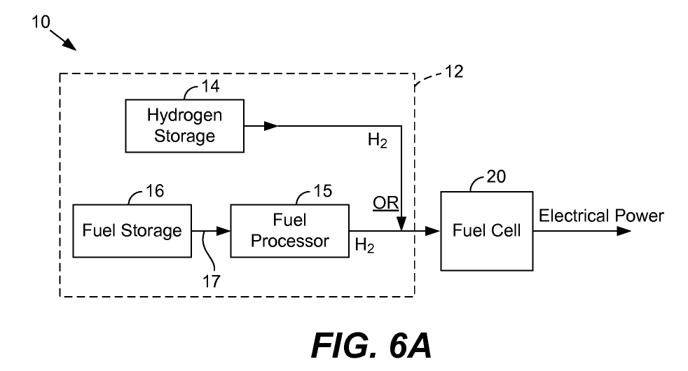

Fuel cell 20 includes two anode manifolds (84 and 86). Each manifold delivers a product or reactant gas to or from the fuel cell stack 60. More specifically, each manifold delivers a gas between a vertical manifold created by stacking the anode flow field plates 202a (FIG. 2B) and plumbing external to fuel cell 20. Inlet hydrogen manifold 84 is disposed on top end plate 64a, couples with an inlet conduit to receive hydrogen gas (such as 25 in FIG. 6B), and opens to an inlet hydrogen manifold 102 (FIG. 5A) that is configured to deliver inlet hydrogen gas to a shared flow field 208a on each anode flow field plate 202a in stack 60. Outlet manifold 86 receives outlet gases from an anode exhaust manifold 104 (FIG. 5A) that is configured to collect waste products from the shared flow field 208a of each anode flow field plate 202a. Outlet manifold 86 may provide the exhaust gases to the ambient space about the fuel cell. In another embodiment, manifold 86 provides the anode exhaust to line 38 (FIG. 6B), which transports the unused hydrogen back to the fuel processor during start-up.

Fuel cell 20 includes two cathode manifolds: an inlet cathode manifold or inlet oxygen manifold 88, and an outlet cathode manifold or outlet water/vapor manifold 90. Inlet oxygen manifold 88 is disposed on top end plate 64a, couples with an inlet conduit (conduit 31, which draws air from the ambient room) to receive ambient air, and opens to an oxygen manifold 106 (FIG. 5A) that is configured to deliver inlet oxygen and ambient air to a shared flow field 208b on each cathode flow field plate 202b in stack 60. Outlet water/vapor manifold 90 receives outlet gases from a cathode exhaust manifold 108 (FIG. 5A) that is configured to collect water (typically as a vapor) from the cathode shared flow fields 208b on each cathode flow field plate 202b.

As shown in FIG. 1A, manifolds 84, 86, 88 and 90 include molded channels that each travel along a top surface of end plate 64a from their interface from outside the fuel cell 20 to a manifold in the stack 60. Each manifold or channel acts as a gaseous communication line for fuel cell 20 and may comprise a molded channel in plate 64 or a housing of fuel cell 20. Other arrangements to communicate gases to and from stack 60 are contemplated, such as those that do not share common manifolds in a single plate or structure.

The flow field plates 202 in stack 60 may each include one or more heat transfer appendages 46. Heat transfer appendages 46 are discussed in further detail below with reference to FIGS. 5A-5C.

As shown in FIG. 1A, stack 60 includes sixteen MEA layers 62, seventeen flow field plates 202, and two end plates 64. The number of flow field plates 202 and MEA layers 62 in each set is not intended to be limiting as any number of flow field plates 202 and MEA layers 62 may be used and may vary with design of fuel cell stack 60. Stacking parallel layers in fuel cell stack 60 permits efficient use of space and increased power density for fuel cell 20 and a fuel cell package 10 including fuel cell 20. In one embodiment, each MEA 62 produces 0.7 V and the number of MEA layers 62 is selected to achieve a desired voltage. Alternatively, the number of MEA layers 62 and flow field plates 202 may be determined by the allowable thickness of package 10. A fuel cell stack 60 having from one MEA 62 to several hundred MEAs 62 may be suitable for many applications. A stack 60 having from about three MEAs 62 to about twenty MEAs 62 may also be suitable for numerous applications. Fuel cell 20 size and layout may also be tailored and configured to output a given power.

FIG. 1B is a cross sectional view of the fuel cell stack 60 illustrated in FIG. 1A. Fuel cell stack 60 includes a plurality of flow field plates 202 and a plurality of MEA layers 62. The flow field plates 202 may be an anode flow field plate 202a or a cathode flow field plate 202b. Two MEAs 62 may neighbor the anode flow field plate 202a and two MEAs 62 may neighbor the cathode flow field plate 202b. In other words, each MEA 62 may be disposed between an anode flow field plate 202a and a cathode flow field plate 202b.

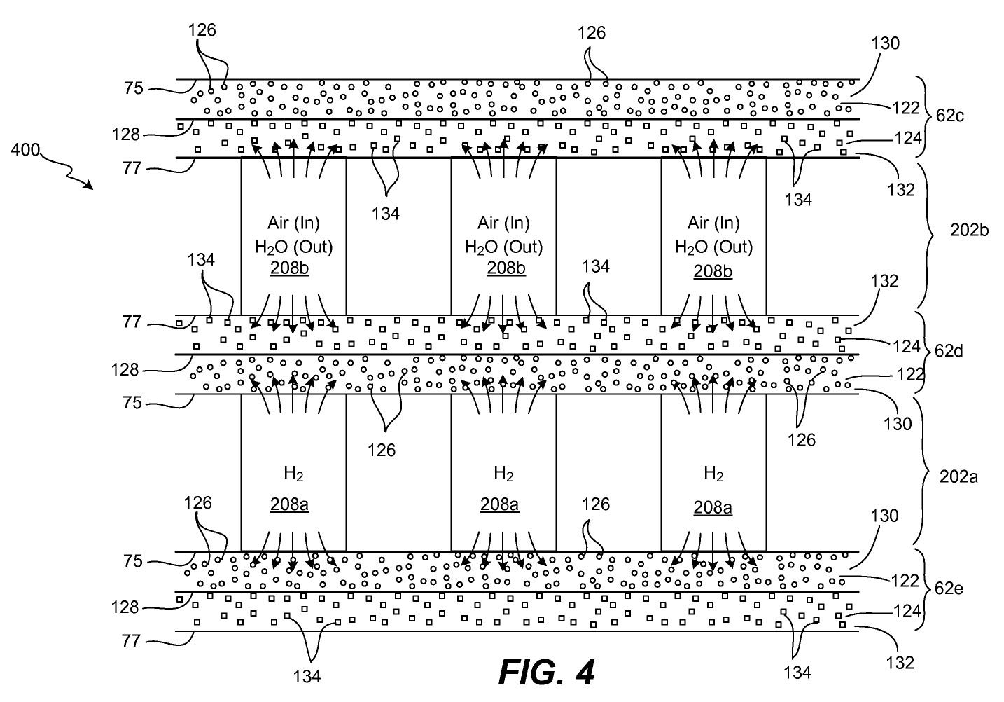

As further described below with reference to FIG. 4, each MEA 62 may have an anode electrode 130 and a cathode electrode 132 separated by an ion conductive membrane 128 disposed between the anode electrode 130 and the cathode electrode 132 to electrically isolate the anode electrode 130 from the cathode electrode 132. Each MEA 62 may be disposed between an anode flow field plate 202a and a cathode flow field plate 202b with the anode electrode 130 adjacent each other and the cathode electrode 132 adjacent each other. This allows for the use of shared flow fields 208 to share reactant gas flow as further described below.

Each flow field plate 202 may have a plurality of through-cut openings to form a plurality of shared flow fields 208 to receive reactant gas flow. An anode flow field plate 202a may have a plurality of shared flow fields 208a to receive a hydrogen gas flow there through. The cathode flow field plate 202b may have a plurality of shared flow fields 208b to receive air or oxygen gas flow there through. Since the through-cut openings are cut through the entire flow field plate 202, the anode shared flow fields 208a and the cathode shared flow fields 208b may thereby be shared by neighboring or adjacent MEAs 62.

Each flow field plate 202 may have a current collector or conductive plate 206, 212 to collect current for either the anode electrode 130 or the cathode electrode 132. A dielectric layer 210 may be disposed in the middle of the conductive plate 206, 212 to electrically isolate the cathode or anode between adjacent MEAs 62, yet allow the reactant gas flow to be shared in the same flow fields. Dielectric layer 210 may be a polymer such as polyimides, polyetheretherketone (PEEK), or liquid crystal polymer (LCP) or may even be an electrically non-conductive ceramic such as alumina or a glass-filled mica. In one embodiment, the dielectric layer 210 may be a ceramic layer and the conductive plate 206, 212 may be a plated metal. In another embodiment, the dielectric layer 210 may be a polymer and the conductive plate 206, 212 may be any known conductive plate used in the flex-circuit industry such as copper. The dielectric layer 210 may be inserted in the middle of the conductive plate 206, 212 by any known laminating process. Current collector 206, 212 may be any conductive material able to collect current, such as copper. In another embodiment, the current collector 206, 212 may be a semiconductor material, such as silicon, that is formed to have through cuts and the top and bottom surface of the plate is doped to be electrically conductive. The middle portion of the current collector may still be electrically insulating between the two conductive surfaces.

As previously discussed, flow field plates 202 include a plurality of through-cuts thereby forming a plurality of shared flow fields 208 on each face of flow field plate 202. Each shared flow field 208 is cut through the dielectric layer 210 and conductive plates 206, 212 such that reactant gases may be shared by adjacent MEAs 62. Each shared flow field 208 distributes one or more reactant gasses to an active area for the fuel cell stack 60. Each shared flow field 208 may also collect reaction byproducts for exhaust from fuel cell 20. When MEAs 62 and flow field plates 202 are stacked together in fuel cell 60, adjacent MEAs are sandwich such that the anode electrode from one MEA is adjacent an anode electrode of the neighboring or adjacent MEA and the cathode electrode from one MEA is adjacent the cathode electrode from a neighboring or adjacent MEA.

As illustrated, cathode conductive plates 206a, 206b may be separated by dielectric layer 210. Cathode conductive plate 206b may collect current generated at cathode electrode 132 in MEA 62c and cathode conductive plate 206b may collect current generated at cathode electrode 132 in adjacent MEA 62d. Anode conductive plate 212a may collect current generated at anode electrode 130 in MEA 62d and anode conductive plate 212b may collect current generated at anode electrode 130 in adjacent MEA 62e. Thus, shared flow fields 208b in cathode flow field plate 202b may be shared by adjacent cathode electrodes 132 in MEA 62c and 62d. Shared flow fields 208a in anode flow field plate 202a may be shared by adjacent anode electrodes 130 in MEA 62d and 62e.

FIGS. 2A, 2B, 2C, and 2D illustrate an exemplary flow field plate used in a fuel cell. FIG. 2A illustrates the various parts of an example flow field plate 202. The flow field plate 202 may have a frame 304a, 304b disposed on the outer edges of the flow field plate 202 on the top 312a and bottom surface 312b of the flow field plate 202. The frame forms a raised portion around the flow field plate to create a seat, socket, or pocket 306 (FIGS. 2C, 2D) to receive a gas diffusion layer (GDL). The frame 304 may be any metal, polymer, laminated metal with a polymer or Graphoil, graphite, ceramic, or any other suitable material. Depending on the material used for the frame 304, the frame 304 may be permanently joined to the flow field plate 202 by laser-welding, brazing, ultrasonic welding, radio frequency welding, heat sealing, or any other joining process. The frame 304 may also be joined to the flow field plate 202 through a compression seal with gaskets or o-rings. As illustrated, frame 304a may be disposed on a top face of the flow field plate 202 and frame 304b may be disposed on the bottom face of the flow field plate 202 to create a seat, socket, or pocket 306 on the top 312a and bottom faces 312b of the flow field plate 202.

Flow field plate 202 may further comprise two conductive plates or current collectors 310. A first conductive plate 310a may be disposed below frame 304a and a second conductive plate 310b may be disposed above frame 304b. The dielectric layer 210 may be disposed between the first conductive plate 310a and the second conductive plate 310b.

Through-cuts may be formed through the conductive plates 310 and dielectric layer 210 to form shared flow fields 208 when all the layers (frame 304, conductive plates 310, and dielectric layer 210) are sandwiched together as illustrated in FIG. 2B. Flow field plate 202 has a relatively flat profile and faces 312 are relatively flat. In one embodiment, flow field plate 202 may have an extension member 314 to facilitate handling of flow field plate 202 to prevent contamination to the conductive plates 310.

FIG. 2C illustrates a plurality of flow field plates stacked for form a fuel cell stack and FIG. 2D illustrates a close-up view of a section of the fuel cell stack of FIG. 2C. FIGS. 2C and 2D are illustrated with the use of a cathode flow field plate 202b but the type of flow field plate is not intended to be limiting as an anode flow field plate may also be used.

Referring to FIGS. 2C and 2D, reactant gas, herein illustrated as pressurized air carrying oxygen gas (O₂), enters fuel cell 20 via oxygen port 88 (FIG. 1A) and flows through the manifold in the direction of arrow A. The reactant gas may be hydrogen gas (H₂) if an anode flow field plate is used. The manifold of the gases are oriented down the length of the fuel cell stack 60 whereby the O₂ gas flows through a gas flow through port 302 in the direction of arrows B. From the gas flow through port 302, the reactant gas may flow into the gas expansion zone around the flow field plate 202 in the direction of arrow C.

The fuel cell stack 60 may contain a GDL 308. The GDL 308 may assist in the transportation or flow of reactant gas to the MEA 62. Any known GDL may be used such as carbon paper, carbon paper that has undergone water repellency treatment, a layer composed of carbon black mixed with a fluororesin (used as a binder/water repellant) and formed on the surface of the carbon paper (or this mixture packed into the pores of carbon paper), and the like.

The GDL 308 may be received by the socket 306 formed in the flow field plate 202. The reactant gas may flow through the GDL 308 in the direction of arrows D and into the shared flow fields 208 and MEA 62. The shared flow fields 208 may be formed from through-cut slits or openings through the flow field plate 202.

Flow field plates 202 are easier to manufacture than current bi-polar plates since the flow field plates 202 use through-cut openings that are easier to manufacture than partial depth cuts in a plate. The through-cut openings may be created by laser-cutting, machining, water-jet cutting, electrode-discharge machining, stamping, or other cutting procedures that are suitable for the materials used for the flow field plate 202. Furthermore, the through-cut openings may be formed with more precision and tolerance than current bi-polar plates. Since a through cut is only a two-dimensional feature, the z-direction depth does not have to be controlled, which simplifies the manufacturing of the flow field plates 202.

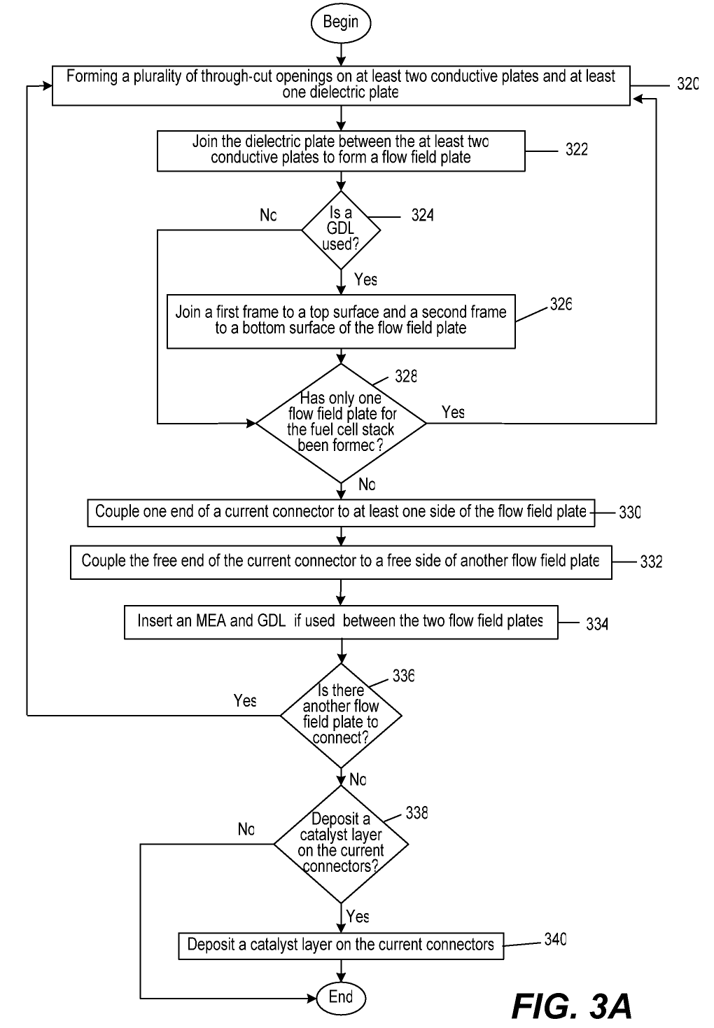

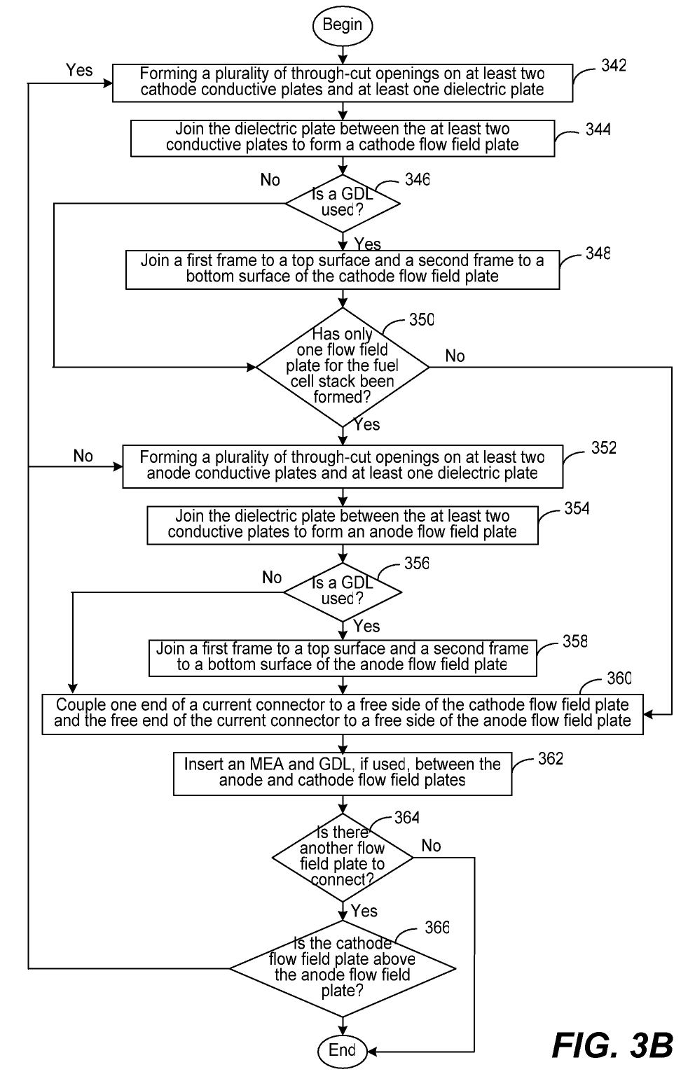

FIGS. 3A and 3B illustrate a flow chart of an example method for manufacturing a fuel cell. Referring now to FIG. 3A, a plurality of through-cut openings may be formed on at least conductive plates and at least one dielectric plate at 320. As stated above, the through-cut openings may be created by laser-cutting, machining, water-jet cutting, electrode-discharge machining, stamping, or other cutting procedures that allows for more precision and tolerance when forming the flow field plate. The conductive plates may be any conductive material able to collect current, such as copper. The dielectric layer may be a polymer such as polyimides, PEEK, or LCP or may even be an electrically non-conductive ceramic such as alumina or a glass-filled mica.

The dielectric plate may be joined or disposed between the two conductive plates to form a flow field plate at 322. The dielectric layer may be inserted in the middle of the conductive plates by any known laminating process. If a GDL is used in the fuel cell at 324, a first frame may be joined to a top surface of the flow field plate and a second frame to a bottom surface of the flow field plate at 326. The GDL may assist in the transportation or flow of reactant gas to the MEA. Any known GDL may be used such as carbon paper, carbon paper that has undergone water repellency treatment, a layer composed of carbon black mixed with a fluororesin (used as a binder/water repellant) and formed on the surface of the carbon paper (or this mixture packed into the pores of carbon paper), and the like.

The frame may create a seat, socket, or pocket on the top and bottom faces of the flow field plate to receive the GDL. The frame may be any metal, polymer, laminated metal with a polymer or Graphoil, graphite, ceramic, or any other suitable material. Depending on the material used for the frame, the frame may be permanently joined to the flow field plate by laser-welding, brazing, ultrasonic welding, radio frequency welding, heat sealing, or any other joining process. The frame may also be joined to the flow field plate through a compression seal with gaskets or o-rings

If only one flow field plate has been formed for the fuel cell at 328, another flow field plate may be formed starting at 320. If the first flow field plate formed is a cathode flow field plate, the next flow field plate formed may be an anode flow field plate. If the first flow field plate formed is an anode flow field plate, the next flow field plate may be an cathode flow field. Thus, the fuel cell stack will have alternating cathode and anode flow field plates. If this is not the first flow field plate formed at 328, one end of a current connector may be coupled to one side of the flow field plate at 330. The current connector or flex circuit may connect the charged conductive plates to other flow field plates.

The free end of the current connector may be coupled to the free side of another flow field plate at 332. The current connector may be folded to join the fuel flow plates in a stack to form a single integrally formed fuel cell stack assembly. In other words, when separated, the flow field plates may form one piece, single accordion or serpentine shaped fuel cell stack. Polyimide laminated frames (adhesive-free lamination processes) may be joined to the flex circuit or deposited as additional layers onto the flex circuit.

An MEA and GDL, if used, may be inserted between the two flow field plates at 334. As stated above, one flow field plate may be an anode flow field plate and the other flow field plate may be a cathode flow field plate. The anode flow field plate may be positioned adjacent the anode electrode of the MEA and the cathode flow field plate may be positioned adjacent the cathode electrode of the MEA.

If there is another flow field plate to connect at 336 to the fuel cell stack, the steps may be repeated from 320. If there are no other flow field plates to connect at 336, a determination of whether a catalyst layer will be deposited on the current connectors may be made at 338. In one embodiment, at the rounded portions, where the folds join the flex circuit, the fuel cell may include an exposed metal layer configured to serve as an external thermal path for heating or cooling through free or forced convection. If a catalyst layer is to be deposited on the current connectors at 338, the catalyst may be disposed on the current connectors at 340.

Referring now to FIG. 3B, a plurality of through-cut openings may be formed on at least two cathode conductive plates and at least one dielectric plate at 342. The dielectric plate may be joined between the two cathode conductive plates to form a cathode flow field plate at 344. If a GDL is used in the fuel cell stack at 346, a first frame may be joined to a top surface of the cathode flow field plate and a second frame may be joined to a bottom surface of the cathode flow field plate at 348. The frame may create a seat, socket, or pocket on the top and bottom faces of the flow field plate to receive the GDL.

If this is the only flow field plate formed for the fuel cell stack at 350, plurality of through-cut openings may be formed on at least two anode conductive plates and at least one dielectric plate at 352. The dielectric plate may be joined between the two anode conductive plates to form a anode flow field plate at 354. If a GDL is used in the fuel cell stack at 356, a first frame may be joined to a top surface of the anode flow field plate and a second frame may be joined to a bottom surface of the anode flow field plate at 358. The frame may create a seat, socket, or pocket on the top and bottom faces of the flow field plate to receive the GDL.

Now that there are at least two flow field plates formed, one end of a current connector may be coupled to a free side of the cathode flow field plate and the free end of the current connector may be coupled to a free side of the anode flow field plate at 360. The current connector may be folded to join the fuel flow plates in a stack to form a single integrally formed fuel cell stack assembly. In other words, when separated, the flow field plates may form one piece, single accordion or serpentine shaped fuel cell stack.

An MEA and GDL, if used, may be inserted between the anode and cathode flow field plates. The anode flow field plate may be positioned adjacent the anode electrode of the MEA and/or the anode diffusion GDL and the cathode flow field plate may be positioned adjacent the cathode electrode of the MEA and/or cathode diffusion GDL. Thus, the reactant gases may be shared by adjacent MEAs. Each shared flow field distributes one or more reactant gasses to an active area on each adjacent MEA. Each shared flow field may also collect reaction byproducts for exhaust from fuel cell. When MEAs and flow field plates are stacked together in fuel cell, adjacent MEAs are sandwich such that the anode electrode from one MEA is adjacent an anode electrode of the neighboring or adjacent MEA and the cathode electrode from one MEA is adjacent the cathode electrode from a neighboring or adjacent MEA.

If there is another flow field plate to connect at 362, and the cathode flow field plate is positioned above the anode flow field plate, the steps may be repeated at 342. In other words, if the last flow field plate is an anode flow field plate, the steps may be repeated at 342. However, if the last flow field plate is a cathode flow field plate (i.e. the anode flow field plate is above the cathode flow field plate), then the steps may be repeated at 352. This ensures that the flow field plates in the fuel cell stack are alternating cathode and anode flow field plates.

FIG. 4 illustrates an example MEA. As illustrated in FIG. 4, the fuel cell stack assembly 400 may be formed of an MEA 62d sandwiched between two flow field plates 202a, 202b. FIG. 4 illustrates an expanded fuel cell stack assembly 400 for clarity.

Anode flow field plate 202a may be sandwiched between MEAs 62d, 62e and cathode flow field plate 202b may be sandwiched between MEAs 62d, 62c. The MEA 62 electrochemically converts hydrogen and oxygen to water and generates electrical energy and heat in the process. MEA 62 includes an anode gas diffusion layer 122, a cathode gas diffusion layer 124, a hydrogen catalyst 126, ion conductive membrane 128, anode electrode 130, cathode electrode 132, and oxygen catalyst 134.

Pressurized hydrogen gas (H₂) enters fuel cell 20 via hydrogen port 84, proceeds through inlet hydrogen manifold 102 (FIG. 5A) and through shared flow fields 208a formed from through-cuts on the anode flow field plate 202a. The shared flow fields 208a open to anode gas diffusion layer 122 on MEA 62d, 62e, which is disposed between the anode face 75 and ion conductive membrane 128 on each MEA 62. The pressure forces hydrogen gas into the hydrogen-permeable anode gas diffusion layer 122 and across the hydrogen catalyst 126, which is disposed in the anode gas diffusion layer 122. When an H₂ molecule contacts the hydrogen catalyst 126, it splits into two H+ ions (protons) and two electrons (e−). The protons move through the ion conductive membrane 128 to combine with oxygen in cathode gas diffusion layer 124. The electrons conduct through the anode electrode 130, where they build potential for use in an external circuit (e.g., a power supply of a laptop computer). After external use, the electrons flow to the cathode electrode 132.

Hydrogen catalyst 126 breaks hydrogen into protons and electrons. Suitable catalysts 126 include platinum, ruthenium, and platinum black or platinum carbon, and/or platinum on carbon nanotubes, for example. Anode gas diffusion layer 122 comprises any material that allows the diffusion of hydrogen there through and is capable of holding the hydrogen catalyst 126 to allow interaction between the catalyst and hydrogen molecules. One such suitable layer comprises a woven or non-woven carbon paper. Other suitable gas diffusion layer 122 materials may comprise a silicon carbide matrix and a mixture of a woven or non-woven carbon paper and Teflon.

On the cathode side of the fuel cell stack assembly 400, pressurized air carrying oxygen gas (O₂) enters fuel cell 20 via oxygen port 88, proceeds through inlet oxygen manifold 106 (FIG. 5A), and through shared flow fields 208b. The shared flow fields 208b open to cathode gas diffusion layer 124 on MEA 62c, 62d, which is disposed between the cathode face 77 and ion conductive membrane 128 of each MEA. The pressure forces oxygen into cathode gas diffusion layer 124 and across the oxygen catalyst 134 disposed in the cathode gas diffusion layer 124. When an O₂ molecule contacts the oxygen catalyst 134, it splits into two oxygen atoms. Two H+ ions that have traveled through the ion selective ion conductive membrane 128 and an oxygen atom combine with two electrons returning from the external circuit to form a water molecule (H₂O). Cathode shared flow fields 208b exhaust the water, which usually forms as a vapor. This reaction in a single MEA layer 62 produces about 0.7 volts.

Cathode gas diffusion layer 124 comprises a material that permits diffusion of oxygen and hydrogen protons there through and is capable of holding the oxygen catalyst 134 to allow interaction between the catalyst 134 with oxygen and hydrogen. Suitable gas diffusion layers 124 may comprise carbon paper or cloth, for example. Other suitable gas diffusion layer 124 materials may comprise a silicon carbide matrix and a mixture of a woven or non-woven carbon paper and Teflon. Oxygen catalyst 134 facilitates the reaction of oxygen and hydrogen to form water. One common catalyst 134 comprises platinum. Many designs employ a rough and porous catalyst 134 to increase surface area of catalyst 134 exposed to the hydrogen or oxygen. For example, the platinum may reside as a powder very thinly coated onto a carbon paper or cloth cathode gas diffusion layer 124.

Ion conductive membrane 128 electrically isolates the anode from the cathode by blocking electrons from passing through membrane 128. Thus, membrane 128 prevents the passage of electrons between gas diffusion layer 122 and gas diffusion layer 124. Ion conductive membrane 128 also selectively conducts positively charged ions, e.g., hydrogen protons from gas diffusion layer 122 to gas diffusion layer 124. For fuel cell 20, protons move through membrane 128 and electrons are conducted away to an electrical load or battery. In one embodiment, ion conductive membrane 128 comprises an electrolyte. One electrolyte suitable for use with fuel cell 20 is Celtec 1000 from BASF Fuel Cells of Frankfurt, Germany. Ion conductive membrane 128 may also employ a phosphoric acid matrix that includes a porous separator impregnated with phosphoric acid. Alternative ion conductive membranes 128 suitable for use with fuel cell 20 are widely available from companies such as United technologies, DuPont, 3M, and other manufacturers known to those of skill in the art. For example, WL Gore Associates of Elkton, Md. produces the primea Series 58, which is a low temperature MEA suitable for use.

In one embodiment, fuel cell 20 requires no external humidifier or heat exchanger and the stack 60 only needs hydrogen and air to produce electrical power. Alternatively, fuel cell 20 may employ humidification of the cathode to fuel cell 20 improve performance. For some fuel cell stack 60 designs, humidifying the cathode increases the power and operating life of fuel cell 20.

FIGS. 5A, 5B, and 5C illustrate exemplary fuel cell stacks. FIG. 5A illustrates a top perspective view of one embodiment of a fuel cell stack (with the top two plates labeled 202p and 202q). Flow field plate 202 is a single plate having a dielectric layer 210 sandwiched between two conductive plates 206, 212 to receive current flow generated from adjacent MEAs 62. (FIG. 1B).

Functionally, a flow field plate a) delivers and distributes reactant gases to gas diffusion layers 122 and 124 and their respective catalysts, b) allows for adjacent MEAs to share the same reactant gas flow thereby reducing the volume of the fuel cell, c) collects and maintains electrical separation of the current between adjacent MEA layers 62 in stack 60, c) exhausts electrochemical reaction byproducts from MEA layers 62, d) facilitates heat transfer to and/or from MEA layers 62 and fuel cell stack 60, and e) includes gas intake and gas exhaust manifolds for gas delivery to other flow field plates 202 in the fuel stack 60.

Structurally, flow field plate 202 has a relatively flat profile and includes opposing top 312a and bottom faces 312b (only top face 312a is shown) and a number of sides 78. Faces 312 are substantially planar with the exception of shared flow fields 208 which are formed as slits or openings through the dielectric layer 210 and conductive plates 206, 212. Sides 78 comprise portions of flow field plate 202 proximate to edges of flow field plate 202 between the two faces 312. As shown, flow field plate 202 is roughly quadrilateral with features for the intake manifolds, exhaust manifolds and heat transfer appendage 46 that provide outer deviation from a quadrilateral shape.

The manifold on each flow field plate 202 is configured to deliver a gas to the shared flow field 208 on the flow field plate 202 or receive a gas from shared flow field 208. The manifolds for flow field plate 202 include the shared flow fields 208 that, when combined with manifolds of other flow field plates 202 in a stack 60, form an inter-plate gaseous communication manifold (such as 102, 104, 106 and 108). Thus, when flow field plates 202 are stacked and their manifolds substantially align, the manifolds permit gaseous delivery to and from each flow field plate 202.

FIG. 5B illustrates another exemplary fuel cell stack and 5C illustrates a detailed section of the fuel cell stack illustrated in FIG. 5B. Referring to FIG. 5B, thermal management of the fuel cell stack 500 may be achieved through conventional means of internal cooling plates or external appendages 46 extending from the high thermally conductive current collector plates 206, 212 on the flow field plates 202, end plates, or a heat sink with free or forced convection. Additionally, the stack 500 may be heated to an operating temperature through electrical heating (resistive heating embedded in the dielectric layers, in the end plate of the stack, or externally) or through chemical heating such as oxidizing a fuel using catalysts on the exterior of the stack 500.

In one embodiment, when using a combination of polyimides and metallic current collectors for the construction of the stack 500, the stack 500 may use flex-circuit technology. If neighboring conductive plates 206, 212 were deposited on a polyimide such as Kapton (made by DuPont), the charged current collectors or conductive plates would be isolated. The charged conductive plates 206, 212 may then be connected through the flex circuit 502 and folded into a stack 500 to form a single integrally formed fuel cell stack assembly. Polyimide laminated frames (adhesive-free lamination processes) may be joined to the flex circuit 502 or deposited as additional layers onto the flex circuit 502.

Since polyimides may be used throughout this example fuel cell stack 500, in the flex circuit 502 and also in the MEA 62, the gas flow paths may be sealed through electromagnetic frequency welding, such as radio frequency (RF) welding. Polyimides are polar polymers or polymers that have a dipole moment. Thus, when a radio frequency or electromagnetic frequency is applied to this polymer, the molecules vibrate and heat up. A heat-seal forms at the boundary of the two polymer pieces so that the two pieces become a continuous polymer thereby allowing for the ability of a cathode flow field plate 202b, an anode flow field plate 202a, and the current connectors 502 to form a single integrally formed fuel cell stack assembly 500. Integral in this sense refers to material continuity between a flow field plate 202 and flex circuit 502. In one embodiment, as illustrated in FIG. 5B, the external appendages may alternate such that the fuel cell stack assembly 500 may resemble a one piece, single accordion or serpentine shaped fuel cell stack when the flow field plates 202 are separated. RF welding of the polyimide may permanently seal the MEA and flow field plates 202.

In one embodiment, at the rounded portions 510, where the folds join the circuit 502, the fuel cell may include an exposed metal layer 504 configured to serve as an external thermal path for heating or cooling through free or forced convection. Catalyst may be disposed on the metal layer 502 to facilitate the production of heat to heat the fuel cell stack assembly 500 as further discussed in detail below. Appendages 46 may be serrated, bent or formed to increased surface area for convection. The appendages 46 may also be increased or decreased in size or formed in different manners to improve flow through these features.

The embodiments discussed herein may reduce fuel cell stack size by about 20% compared to bipolar plate stacks currently used. Use of the flow field plates may also reduce manufacturing costs, reduce weight, and use readily available processes. Additionally, by sharing flow fields with the flow field plates, this may reduce fuel cell stack height. Fuel cell stack height may also be reduced by tailoring the height or channel depth of the flow field plates to the anode and/or cathode flow performance. For example, the anode flow rate may be low that it may be necessary to have a shallower height or channel depth. This may also reduce fuel cell stack height. Folding a flex circuit makes current connection for the fuel cell stack less complicated and more manufacturable.

Referring to FIGS. 5A and 5C, flow field plate 202 may include one or more heat transfer appendages 46. Each heat transfer appendage 46 permits external thermal management of internal portions of fuel cell stack 60. More specifically, appendage 46 may be used to heat or cool internal portions of fuel cell stack 60 such as internal portions of each flow field plate 202 and any neighboring MEA layers 62, for example. Heat transfer appendage 46 may be arranged outside the fuel cell 500 laterally, in a curved shape, or in any other suitable arrangement. In one embodiment, appendage 46 is disposed on an external portion of flow field plate 202. External portions of flow field plate 202 may include any portions of plate 202 proximate to a side or edge of the substrate included in plate 202. For the embodiment shown, heat transfer appendage 46 substantially spans a side of plate 202 that does not include intake and output manifolds 102-108.

Peripherally disposing heat transfer appendage 46 allows heat transfer between inner portions of plate 202 and the externally disposed appendage 46 via the flow field plate 202. Conductive thermal communication refers to heat transfer between bodies that are in contact or that are integrally formed. Thus, lateral conduction of heat between external portions of plate 202 (where the heat transfer appendage 46 attaches) and central portions of flow field plate 202 occurs via conductive thermal communication through flow field plate 202. In one embodiment, heat transfer appendage 46 is integral with the flow field plate 202. Integral in this sense refers to material continuity between appendage 46 and plate 202. An integrally formed appendage 46 may be formed with plate 202 in a single molding, stamping, machining or MEMs process of a single metal sheet, for example. Integrally forming appendage 46 and plate 202 permits conductive thermal communication and heat transfer between plate 202 and the heat transfer appendage 46. In another embodiment, appendage 46 comprises a material other than that used to from the flow field plate 202 and is attached onto plate 202 and conductive thermal communication and heat transfer occurs at the junction of attachment between the two attached materials.

Heat may travel to or from the heat transfer appendage 46. In other words, appendage 46 may be employed as a heat sink or source. Thus, heat transfer appendage 46 may be used as a heat sink to cool internal portions of flow field plate 202 or an MEA 62. Fuel cell 20 employs a cooling medium to remove heat from appendage 46. Alternatively, heat transfer appendage 46 may be employed as a heat source to provide heat to internal portions of flow field plate 202 or an MEA 62. In this case, a catalyst 192 may be disposed on appendage 46 to generate heat in response to the presence of a heating medium.

For cooling, heat transfer appendage 46 permits integral conductive heat transfer from portions of plate 202 to the externally disposed appendage 46. During hydrogen consumption and electrical energy production, the electrochemical reaction generates heat in each MEA 62. Since portions of flow field plate 202 are in contact with the MEA 62, a heat transfer appendage 46 on a flow field plate 202 thus cools an MEA 62 adjacent to the plate via a) conductive heat transfer from MEA 62 to flow field plate 202 and b) lateral thermal communication and conductive heat transfer from the flow field plate 202 in contact with the MEA 62 to external portions of flow field plate 202 that includes appendage 46. In this case, heat transfer appendage 46 sinks heat from the flow field plates 208. When a fuel cell stack 60 includes multiple MEA layers 62, lateral thermal communication through each flow field plate 202 in this manner provides interlayer cooling of multiple MEA layers 62 in stack 60—including those layers in central portions of stack 60.

Fuel cell 20 may employ a cooling medium that passes over heat transfer appendage 46. The cooling medium receives heat from appendage 46 and removes the heat from fuel cell 20. Heat generated internal to stack 60 thus conducts through flow field plate 202, to appendage 46, and heats the cooling medium via convective heat transfer between the appendage 46 and cooling medium. Air is suitable for use as the cooling medium.

Heat transfer appendage 46 may be configured with a thickness that is less than the thickness between opposite faces 312 of plate 202. The reduced thickness of appendages 46 on adjacent flow field plates 202 in the fuel cell stack 60 forms a channel between adjacent appendages. Multiple adjacent flow field plates 202 and appendages 46 in stack form numerous channels. Each channel permits a cooling medium or heating medium to pass there through and across heat transfer appendages 46. In one embodiment, fuel cell stack 60 includes a mechanical housing that encloses and protects stack 60. Walls of the housing also provide additional ducting for the cooling or heating medium by forming ducts between adjacent appendages 46 and the walls.

The cooling medium may be a gas or liquid. Heat transfer advantages gained by high conductance flow field plates 202 allow air to be used as a cooling medium to cool heat transfer appendages 46 and stack 60. For example, a DC-fan 37 (FIG. 6B) may be attached to an external surface of the mechanical housing. The fan 37 moves air through the channels between appendages to cool heat transfer appendages 46 and fuel cell stack 60, and out an exhaust hole or port in the mechanical housing. Fuel cell system 10 may then include active thermal controls based on temperature sensed feedback. Increasing or decreasing coolant fan speed regulates the amount of heat removal from stack 60 and the operating temperature for stack 60. In one embodiment of an air-cooled stack 60, the coolant fan speed increases or decreases as a function of the actual cathode exit temperature, relative to a desired temperature set-point.

For heating, heat transfer appendage 46 allows integral heat transfer from the externally disposed appendage 46 to flow field plate 202 and any components and portions of fuel cell 20 in thermal communication with flow field plate 202. A heating medium passed over the heat transfer appendage 46 provides heat to the appendage. Heat convected onto the appendage 46 then conducts through the substrate 89 and into flow field plate 202 and stack 60, such as portions of MEA 62 and its constituent components.

In one embodiment, the heating medium comprises a heated gas having a temperature greater than that of appendage 46. Exhaust gases from heater 30 or reformer 32 of fuel processor 15 may each include elevated temperatures that are suitable for heating one or more appendages 46 (FIG. 6B).

In another embodiment, fuel cell may comprise a catalyst 192 disposed in contact with, or in proximity to, one or more heat transfer appendages 46. As illustrated, in FIG. 5C, the catalyst 192 may be disposed outside the fuel cell stack 500 or within the rounded portions 510 of the flex circuit 502. The catalyst 192 generates heat when the heating medium passes over it. The heating medium in this case may comprise any gas or fluid that reacts with catalyst 192 to generate heat. Typically, catalyst 192 and the heating medium employ an exothermic chemical reaction to generate the heat. Heat transfer appendage 46 and plate 202 then transfer heat into the fuel cell stack 60, e.g. to heat internal MEA layers 62. For example, catalyst 192 may comprise platinum and the heating medium includes the hydrocarbon fuel source 17. The fuel source 17 may be heated to a gaseous state before it enters fuel cell 20. This allows gaseous transportation of the heating medium and gaseous interaction between the fuel source 17 and catalyst 192 to generate heat. Similar to the cooling medium described above, a fan disposed on one of the walls then moves the gaseous heating medium within fuel cell 20.

In a specific embodiment, the hydrocarbon fuel source 17 used to react with catalyst 192 comes from a reformer exhaust 32 (FIG. 6B) or heater exhaust in fuel processor 15. This advantageously pre-heats the fuel source 17 before receipt within fuel cell 20 and also efficiently uses or burns any fuel remaining in the reformer or heater exhaust after processing by fuel processor 15. Alternatively, fuel cell 20 may include a separate hydrocarbon fuel source 17 feed that directly supplies hydrocarbon fuel source 17 to fuel cell 20 for heating and reaction with catalyst 192. In this case, catalyst 192 may comprise platinum. Other suitable catalysts 192 include palladium, a platinum/palladium mix, iron, ruthenium, and combinations thereof. Each of these will react with a hydrocarbon fuel source 17 to generate heat. Other suitable heating mediums include hydrogen or any heated gases emitted from fuel processor 15, for example.

When hydrogen is used as the heating medium, catalyst 192 comprises a material that generates heat in the presence of hydrogen, such as palladium or platinum. As will be described in further detail below, the hydrogen may include hydrogen supplied from the reformer 32 in fuel processor 15 as exhaust.

As shown in FIG. 5C, catalyst 192 is arranged on, and in contact with, each heat transfer appendage 46. In this case, the heating medium passes over each appendage 46 and reacts with catalyst 192. This generates heat, which is absorbed via conductive thermal communication by the cooler appendage 46. Wash coating may be employed to dispose catalyst 192 on each appendage 46. A ceramic support may also be used to bond catalyst 192 on an appendage 46.

For catalyst-based heating, heat then a) transfers from catalyst 192 to appendage 46, b) moves laterally though flow field plate 202 via conductive heat transfer from lateral portions of the plate that include heat transfer appendage 46 to portions of flow field plate 202 in contact with the MEA layers 62, and c) conducts from flow field plate 202 to MEA layer 62. When a fuel cell stack 60 includes multiple MEA layers 62, lateral heating through each flow field plate 202 provides interlayer heating of multiple MEA layers 62 in stack 60, which expedites fuel cell 20 warm up.

Flow field plates 202 of FIG. 5B include heat transfer appendages 46 on each side. In one embodiment, one set of heat transfer appendages 46a is used for cooling while the other set of heat transfer appendages 46b is used for heating. Flow field plates 202 illustrated in FIG. 5A illustrate plates 202 with four heat transfer appendages 46 disposed on three sides of stack 60. Appendage 46 arrangements can be otherwise varied to affect and improve heat dissipation and thermal management of fuel cell stack 60 according to other specific designs. For example, appendages 46 need not span a side of plate 202 as shown and may be tailored based on how the heating fluid is channeled through the housing.

Fuel Cell System Overview

Fuel cell systems that benefit from embodiments described herein will be described. FIG. 6A illustrates a fuel cell system 10 for producing electrical energy in accordance with one embodiment. As shown, ‘reformed’ hydrogen system 10 includes a fuel processor 15 and fuel cell 20, with a fuel storage device 16 coupled to system 10 for fuel provision. System 10 processes a fuel 17 to produce hydrogen for fuel cell 20.

Storage device, or cartridge, 16 stores a fuel 17, and may comprise a refillable and/or disposable device. Either design permits recharging capability for system 10 or an electronics device using the output electrical power by swapping a depleted cartridge for one with fuel. A connector on cartridge 16 interfaces with a mating connector on system 10 or the electronics device to permit fuel transfer from the cartridge. In a specific embodiment, cartridge 16 includes a bladder that contains the fuel 17 and conforms to the volume of fuel in the bladder. An outer rigid housing of device 16 provides mechanical protection for the bladder. The bladder and housing permit a wide range of cartridge sizes with fuel capacities ranging from a few milliliters to several liters. In one embodiment, the cartridge is vented and includes a small hole, single direction flow valve, hydrophobic filter, or other aperture to allow air to enter the fuel cartridge as fuel 17 is consumed and displaced from the cartridge. In another specific embodiment, the cartridge includes ‘smarts’, or a digital memory used to store information related to usage of device 16.

A pressure source moves fuel 17 from storage device 16 to fuel processor 15. In a specific embodiment, a pump in system 10 draws fuel from the storage device. Cartridge 16 may also be pressurized with a pressure source such as a compressible foam, spring, or a propellant internal to the housing that pushes on the bladder (e.g., propane or compressed nitrogen gas). In this case, a control valve in system 10 regulates fuel flow. Other fuel cartridge designs suitable for use herein may include a wick that moves a liquid fuel from within cartridge 16 to a cartridge exit. If system 10 is load following, then a sensor meters fuel delivery to processor 15, and a control system in communication with the sensor regulates the fuel flow rate as determined by a desired power level output of fuel cell 20.

Fuel 17 acts as a carrier for hydrogen and can be processed or manipulated to separate hydrogen. The terms ‘fuel’, ‘fuel source’ and ‘hydrogen fuel source’ are interchangeable herein and all refer to any fluid (liquid or gas) that can be manipulated to separate hydrogen. Liquid fuels 17 offer high energy densities and the ability to be readily stored and shipped. Fuel 17 may include any hydrogen bearing fuel stream, hydrocarbon fuel or other source of hydrogen such as ammonia. Currently available hydrocarbon fuels 17 suitable for use with system 10 include gasoline, C₁ to C₄ hydrocarbons, their oxygenated analogues and/or their combinations, for example. Other fuel sources may be used with system 10, such as sodium borohydride. Several hydrocarbon and ammonia products may also be used.

Fuel 17 may be stored as a fuel mixture. When the fuel processor 15 comprises a steam reformer, for example, storage device 16 includes a fuel mixture of a hydrocarbon fuel and water. Hydrocarbon fuel/water mixtures are frequently represented as a percentage of fuel in water. In one embodiment, fuel 17 comprises methanol or ethanol concentrations in water in the range of 1-99.9%. Other liquid fuels such as butane, propane, gasoline, military grade “JP8”, etc. may also be contained in storage device 16 with concentrations in water from 5-100%. In a specific embodiment, fuel 17 comprises 67% methanol by volume.

Fuel processor 15 receives methanol 17 and outputs hydrogen. In one embodiment, a hydrocarbon fuel processor 15 heats and processes a hydrocarbon fuel 17 in the presence of a catalyst to produce hydrogen. Fuel processor 15 comprises a reformer, which is a catalytic device that converts a liquid or gaseous hydrocarbon fuel 17 into hydrogen and carbon dioxide. As the term is used herein, reforming refers to the process of producing hydrogen from a fuel 17. Fuel processor 15 may output either pure hydrogen or a hydrogen bearing gas stream (also commonly referred to as ‘reformate’).

In another embodiment, hydrogen supply 12 provides hydrogen to fuel cell 20. As shown, supply 12 includes a hydrogen storage device 14 and/or a ‘reformed’ hydrogen supply. Fuel cell 20 typically receives hydrogen from one supply at a time, although fuel cell systems 10 that employ redundant hydrogen provision from multiple supplies are useful in some applications. Hydrogen storage device 14 outputs hydrogen, which may be a pure source such as compressed hydrogen held in a pressurized container 14. A solid-hydrogen storage system such as a metal-based hydrogen storage device known to those of skill in the art may also be used for hydrogen storage device 14.

Various types of reformers are suitable for use in fuel cell system 10; these include steam reformers, auto thermal reformers (ATR) and catalytic partial oxidizers (CPOX) for example. A steam reformer only needs steam and fuel to produce hydrogen. ATR and CPOX reformers mix air with a fuel/steam mixture. ATR and CPOX systems reform fuels such as methanol, diesel, regular unleaded gasoline and other hydrocarbons. In a specific embodiment, storage device 16 provides methanol 17 to fuel processor 15, which reforms the methanol at about 280 degrees Celsius or less and allows fuel cell system 10 usage in low temperature applications.

Fuel cell 20 electrochemically converts hydrogen and oxygen to water, generating electrical energy (and sometimes heat) in the process. Ambient air readily supplies oxygen. A pure or direct oxygen source may also be used. The water often forms as a vapor, depending on the temperature of fuel cell 20. For some fuel cells, the electrochemical reaction may also produce carbon dioxide as a byproduct.

In one embodiment, fuel cell 20 is a low volume ion conductive membrane (PEM) fuel cell suitable for use with portable applications and consumer electronics. In another embodiment, the fuel cell may be the fuel cell described above. A PEM fuel cell comprises a membrane electrode assembly (MEA) that carries out the electrical energy generating an electrochemical reaction. The MEA includes a hydrogen catalyst, an oxygen catalyst, and an ion conductive membrane that a) selectively conducts protons and b) electrically isolates the hydrogen catalyst from the oxygen catalyst. One suitable MEA is model number Celtec 1000 as provided by BASF Fuel Cells of Frankfurt, Germany. A hydrogen gas distribution layer may also be included; it contains the hydrogen catalyst and allows the diffusion of hydrogen therethrough. An oxygen gas distribution layer contains the oxygen catalyst and allows the diffusion of oxygen and hydrogen protons therethrough. Typically, the ion conductive membrane separates the hydrogen and oxygen gas distribution layers. In chemical terms, the anode comprises the hydrogen gas distribution layer and hydrogen catalyst, while the cathode comprises the oxygen gas distribution layer and oxygen catalyst.

In one embodiment, the fuel cell stack may be the exemplary fuel cell discussed above. In another embodiment, a PEM fuel cell may include a fuel cell stack having a set of bi-polar plates. In an embodiment, each bi-polar plate is formed from a thin single sheet of metal that includes channel fields on opposite surfaces of the metal sheet. Thickness for these plates is typically below about 5 millimeters, and compact fuel cells for portable applications may employ plates thinner than about 2 millimeters. The single bi-polar plate thus dually distributes hydrogen and oxygen; one channel field distributes hydrogen while a channel field on the opposite surface distributes oxygen. In another embodiment, each bi-polar plate is formed from multiple layers that include more than one sheet of metal. Multiple bi-polar plates can be stacked to produce the ‘fuel cell stack’ in which a membrane electrode assembly is disposed between each pair of adjacent bi-polar plates. Gaseous hydrogen distribution to the hydrogen gas distribution layer in the MEA occurs via a channel field on one plate while oxygen distribution to the oxygen gas distribution layer in the MES occurs via a channel field on a second plate on the other surface of the membrane electrode assembly.

In electrical terms, the anode includes the hydrogen gas distribution layer, hydrogen catalyst and a bi-polar plate. The anode acts as the negative electrode for fuel cell 20 and conducts electrons that are freed from hydrogen molecules so that they can be used externally, e.g., to power an external circuit or stored in a battery. In electrical terms, the cathode includes the oxygen gas distribution layer, oxygen catalyst and an adjacent bi-polar plate. The cathode represents the positive electrode for fuel cell 20 and conducts the electrons back from the external electrical circuit to the oxygen catalyst, where they can recombine with hydrogen ions and oxygen to form water.

In a fuel cell stack, the assembled bi-polar plates are connected in series to add electrical potential gained in each layer of the stack. The term ‘bi-polar’ refers electrically to a bi-polar plate (whether mechanically comprised of one plate or two plates) sandwiched between two membrane electrode assembly layers. In a stack where plates are connected in series, a bi-polar plate acts as both a negative terminal for one adjacent (e.g., above) membrane electrode assembly and a positive terminal for a second adjacent (e.g., below) membrane electrode assembly arranged on the opposite surface of the bi-polar plate.

In a PEM fuel cell, the hydrogen catalyst separates the hydrogen into protons and electrons. The ion conductive membrane blocks the electrons, and electrically isolates the chemical anode (hydrogen gas distribution layer and hydrogen catalyst) from the chemical cathode. The ion conductive membrane also selectively conducts positively charged ions. Electrically, the anode conducts electrons to a load (electrical energy is produced) or battery (energy is stored). Meanwhile, protons move through the ion conductive membrane. The protons and used electrons subsequently meet on the cathode side, and combine with oxygen to form water. The oxygen catalyst in the oxygen gas distribution layer facilitates this reaction. One common oxygen catalyst comprises platinum powder thinly coated onto a carbon paper or cloth. Many designs employ a rough and porous catalyst to increase surface area of the platinum exposed to the hydrogen and oxygen. A fuel cell suitable for use herein is further described in commonly owned patent application Ser. No. 11/120,643, entitled “Compact Fuel Cell Package”, which is incorporated by reference in its entirety for all purposes.

Since the electrical generation process in fuel cell 20 is exothermic, fuel cell 20 may implement a thermal management system to dissipate heat. Fuel cell 20 may also employ a number of humidification plates (HP) to manage moisture levels in the fuel cell.

While system 10 will mainly be discussed with respect to PEM fuel cells, it is understood that system 10 may be practiced with other fuel cell architectures, such as the exemplary fuel cell discussed above. The main difference between fuel cell architectures is the type of ion conductive membrane used. In another embodiment, fuel cell 20 is phosphoric acid fuel cell that employs liquid phosphoric acid for ion exchange. Solid oxide fuel cells employ a hard, non-porous ceramic compound for ion exchange and may be suitable for use with embodiments described herein. Other suitable fuel cell architectures may include alkaline and molten carbonate fuel cells, for example.

FIG. 6B illustrates schematic operation for the fuel cell system 10 of FIG. 6A in accordance with a specific embodiment. Fuel cell system 10 is included in a portable package 11. In this case, package 11 includes fuel cell 20, fuel processor 15, and all other balance-of-plant components except cartridge 16. As the term is used herein, a fuel cell system package 11 refers to a fuel cell system that receives a fuel and outputs electrical energy. At a minimum, this includes a fuel cell and fuel processor. The package need not include a cover or housing, e.g., in the case where a fuel cell, or a fuel cell and fuel processor, is included in a battery bay of a laptop computer. In this case, the portable fuel cell system package 11 only includes the fuel cell, or fuel cell and fuel processor, and no housing. The package may include a compact profile, low volume, or low mass—any of which is useful in any power application where size is relevant.

Package 11 is divided into two parts: a) an engine block 12 and b) all other parts and components of system 10 in the portable package 11 not included in engine block 12. In one embodiment, engine block 12 includes the core power-producing mechanical components of system 10. At a minimum, this includes fuel processor 15 and fuel cell 20. It may also include any plumbing configured to transport fluids between the two. Other system components included in engine block 12 may include: one or more sensors for fuel processor 15 and fuel cell 20, a glow plug or electrical heater for fuel heating in fuel processor during start-up, and/or one or more cooling components. Engine block 12 may include other system components.

Components outside of engine block 12 may include: a body for the package, connector 23, inlet and outlet plumbing for system fluids to or from fuel processor 15 or fuel cell 20, one or more compressors or fans, electronic controls, system pumps and valves, any system sensors, manifolds, heat exchangers and electrical interconnects useful for carrying out functionality of fuel cell system 10.

In one embodiment, the engine block 12 includes a fuel cell, a fuel processor, and dedicated mechanical and fluidic connectivity between the two. The dedicated connectivity may provide a) fluid or gas communication between the fuel processor and the fuel cell, and/or b) structural support between the two or for the package. In one embodiment, an interconnect, which is a separate device dedicated to interconnecting the two devices, provides much of the connectivity. In another embodiment, direct and dedicated connectivity is provided on the fuel cell and/or fuel processor to interface with the other. For example, a fuel cell may be designed to interface with a particular fuel processor and includes dedicated connectivity for that fuel processor. Alternatively, a fuel processor may be designed to interface with a particular fuel cell. Assembling the fuel processor and fuel cell together in a common and substantially enclosed package 11 provides a portable ‘black box’ device that receives a fuel and outputs electrical energy.

In one embodiment, system 10 is sold as a physical engine block 12 plus specifications for interfacing with the engine block 12. The specifications may include desired cooling rates, airflow rates, physical sizing, heat capture and release information, plumbing specifications, fuel inlet parameters such as the fuel type, mixture and flow rates, etc. This permits engine block 12 to be sold as a core component employed in a wide variety of devices determined by the engine block purchaser. Sample devices include: portable fuel cell systems, consumer electronics components such as laptop computers, and custom electronics devices.

Fuel storage device 16 stores methanol or a methanol mixture as a hydrogen fuel 17. An outlet of storage device 16 includes a connector 23 that couples to a mating connector on package 11. In a specific embodiment, connector 23 and mating connector form a quick connect/disconnect for easy replacement of cartridges 16. The mating connector communicates methanol 17 into hydrogen fuel line 25, which is internal to package 11.

Line 25 divides into two lines: a first line 27 that transports methanol 17 to a burner/heater 30 for fuel processor 15 and a second line 29 that transports methanol 17 for a reformer 32 in fuel processor 15. Lines 25, 27 and 29 may comprise channels disposed in the fuel processor (e.g., channels in one or more metal components) and/or tubes leading thereto.

As the term is used herein, a line refers to one or more conduits or channels that communicate a fluid (a gas, liquid, or combination thereof). For example, a line may include a separable plastic conduit. In a specific embodiment to reduce package size, the fuel cell and the fuel processor may each include a molded channel dedicated to the delivering hydrogen from the processor to the cell. The channeling may be included in a structure for each. When the fuel cell attaches directly to the fuel processor, the hydrogen transport line then includes a) channeling in the fuel processor to deliver hydrogen from a reformer to the connection, and b) channeling in the fuel cell to deliver the hydrogen from the connection to a hydrogen intake manifold. An interconnect may also facilitate connection between the fuel cell and the fuel processor. The interconnect includes an integrated hydrogen conduit dedicated to hydrogen transfer from the fuel processor to the fuel cell. Other plumbing techniques known to those of skill in the art may be used to transport fluids in a line.

Flow control is provided on each line 27 and 29. In this embodiment, separate pumps 21a and 21b are provided for lines 27 and 29, respectively, to pressurize each line separately and transfer methanol at independent rates, if desired. A model 030SP-S6112 pump as provided by Biochem, N.J. is suitable to transmit liquid methanol on either line in a specific embodiment. In another embodiment, a single pump may be used to control each line 27, 29 such as the use of a peristaltic pump and a lee valve. A diaphragm or piezoelectric pump is also suitable for use with system 10. A flow restriction may also be provided on each line 27 and 29 to facilitate sensor feedback and flow rate control. In conjunction with suitable control, such as digital control applied by a processor that implements instructions from stored software, each pump 21 responds to control signals from the processor and moves a desired amount of methanol 17 from storage device 16 to heater 30 and reformer 32 on each line 27 and 29.

Air source 41 delivers oxygen and air from the ambient room through line 31 to the cathode in fuel cell 20, where some oxygen is used in the cathode to generate electricity. Air source 41 may include a pump, fan, blower, or compressor, for example.

High operating temperatures in fuel cell 20 also heat the oxygen and air. In the embodiment shown, the heated oxygen and air is then transmitted from the fuel cell, via line 33, to a regenerator 36 (also referred to herein as a ‘dewar’) of fuel processor 15, where the air is additionally heated (by escaping heat from heater 30) before the air enters heater 30. This double pre-heating increases efficiency of fuel cell system 10 by a) reducing heat lost to reactants in heater 30 (such as fresh oxygen that would otherwise be near room temperature when combusted in the heater), and b) cooling the fuel cell during energy production. In a specific embodiment, a model BTC compressor as provided by Hargraves, N.C. is suitable to pressurize oxygen and air for fuel cell system 10.

When fuel cell cooling is needed, a fan 37 blows air from the ambient room over fuel cell 20. Fan 37 may be suitably sized to move air as desired by the heating requirements of fuel cell 20; and many vendors known to those of skill in the art provide fans and blowers suitable for use with package 10.

Fuel processor 15 is configured to process fuel 17 and output hydrogen. Fuel processor 15 comprises heater 30, reformer 32, boiler 34, and regenerator 36. Heater 30 (also referred to herein as a burner when it uses catalytic combustion to generate heat) includes an inlet that receives methanol 17 from line 27. In a specific embodiment, the burner includes a catalyst that helps generate heat from methanol, such as platinum or palladium coated onto a suitable support or alumina pellets for example.

In a specific embodiment, heater 30 includes its own boiler to preheat fuel for the heater. Boiler 34 includes a chamber having an inlet that receives methanol 17 from line 29. The boiler chamber is configured to receive heat from heater 30, via heat conduction through one or more walls between the boiler 34 and heater 30, and use the heat to boil the methanol passing through the boiler chamber. The structure of boiler 34 permits heat produced in heater 30 to heat methanol 17 in boiler 34 before reformer 32 receives the methanol 17. In a specific embodiment, the boiler chamber is sized to boil methanol before receipt by reformer 32. Boiler 34 includes an outlet that provides heated methanol 17 to reformer 32.

Reformer 32 includes an inlet that receives heated methanol 17 from boiler 34. A catalyst in reformer 32 reacts with the methanol 17 to produce hydrogen and carbon dioxide; this reaction is endothermic and draws heat from heater 30. A hydrogen outlet of reformer 32 outputs hydrogen to line 39. In one embodiment, fuel processor 15 also includes a preferential oxidizer that intercepts reformer 32 hydrogen exhaust and decreases the amount of carbon monoxide in the exhaust. The preferential oxidizer employs oxygen from an air inlet to the preferential oxidizer and a catalyst, such as ruthenium that is preferential to carbon monoxide over hydrogen.

Regenerator 36 pre-heats incoming air before the air enters heater 30. In one sense, regenerator 36 uses outward traveling waste heat in fuel processor 15 to increase thermal management and thermal efficiency of the fuel processor. Specifically, waste heat from heater 30 pre-heats incoming air provided to heater 30 to reduce heat transfer to the air within the heater. As a result, more heat transfers from the heater to reformer 32. The regenerator also functions as insulation. More specifically, by reducing the overall amount of heat loss from fuel processor 15, regenerator 36 also reduces heat loss from package 11. This enables a cooler fuel cell system 10 package.

In one embodiment, fuel processor 15 includes a monolithic structure having common walls between the heater 30 and other chambers in the fuel processor. Fuel processors suitable for use herein are further described in commonly owned patent application Ser. No. 10/877,044.

Line 39 transports hydrogen (or ‘reformate’) from fuel processor 15 to fuel cell 20. In a specific embodiment, gaseous delivery lines 33, 35 and 39 include channels in a metal interconnect that couples to both fuel processor 15 and fuel cell 20. A hydrogen flow sensor (not shown) may also be added on line 39 to detect and communicate the amount of hydrogen being delivered to fuel cell 20. In conjunction with the hydrogen flow sensor and suitable control, such as digital control applied by a processor that implements instructions from stored software, system 10 regulates hydrogen gas provision to fuel cell 20.

Fuel cell 20 includes a hydrogen inlet port that receives hydrogen from line 39 and includes a hydrogen intake manifold that delivers the gas to one or more bi-polar plates and their hydrogen distribution channels. An oxygen inlet port of fuel cell 20 receives oxygen from line 31; an oxygen intake manifold receives the oxygen from the port and delivers the oxygen to one or more bi-polar plates and their oxygen distribution channels. A cathode exhaust manifold collects gases from the oxygen distribution channels and delivers them to a cathode exhaust port and line 33, or to the ambient room. An anode exhaust manifold 38 collects gases from the hydrogen distribution channels, and in one embodiment, delivers the gases to the ambient room.

In a specific embodiment, and as shown, the anode exhaust is transferred back to fuel processor 15. In this case, system 10 comprises plumbing 38 that transports unused hydrogen from the anode exhaust to heater 30. For system 10, heater 30 includes two inlets: an inlet configured to receive fuel 17 and an inlet configured to receive hydrogen from line 38. Heater 30 then includes a thermal catalyst that reacts with the unused hydrogen to produce heat. Since hydrogen consumption within a PEM fuel cell 20 is often incomplete and the anode exhaust often includes unused hydrogen, re-routing the anode exhaust to heater 30 allows a fuel cell system to capitalize on unused hydrogen and increase hydrogen usage and energy efficiency. The fuel cell system thus provides flexibility to use different fuels in a catalytic heater 30. For example, if fuel cell 20 can reliably and efficiently consume over 90% of the hydrogen in the anode stream, then there may not be sufficient hydrogen to maintain reformer and boiler operating temperatures in fuel processor 15. Under this circumstance, methanol supply is increased to produce additional heat to maintain the reformer and boiler temperatures. In one embodiment, gaseous delivery in line 38 back to fuel processor 15 relies on pressure at the exhaust of the anode gas distribution channels, e.g., in the anode exhaust manifold. In another embodiment, an anode recycling pump or fan is added to line 38 to pressurize the line and return unused hydrogen back to fuel processor 15. The unused hydrogen is then combusted for heat generation.

In one embodiment, fuel cell 20 includes one or more heat transfer appendages 46 that permit conductive heat transfer with internal portions of a fuel cell stack. This may be done for heating and/or cooling fuel cell 20. In a specific heating embodiment, exhaust 35 of heater 30 is transported to the one or more heat transfer appendages 46 during system start-up to expedite reaching initial elevated operating temperatures in fuel cell 20. The heat may come from hot exhaust gases or unburned fuel in the exhaust, which then interacts with a catalyst disposed on or in proximity with a heat transfer appendage 46. In a specific cooling embodiment, fan 37 blows cooling air over the one or more heat transfer appendages 46, which provides dedicated and controllable cooling of the stack during electrical energy production. Fuel cells suitable for use herein are further described in commonly owned patent application Ser. No. 10/877,770, entitled “Micro Fuel Cell Thermal Management”, filed Jun. 25, 2004, which is incorporated by reference in its entirety for all purposes.

Heat exchanger 42 transfers heat from fuel cell system 10 to the inlet fuel 17 before the methanol reaches fuel processor 15. This increases thermal efficiency for system 10 by preheating the incoming fuel (to reduce heating of the fuel in heater 30) and reuses heat that would otherwise be expended from the system. While system 10 shows heat exchanger 42 heating methanol in line 29 that carries fuel 17 to the boiler 34 and reformer 32, it is understood that heat exchanger 42 may be used to heat methanol in line 27 that carries fuel 17 to burner 30.

In one embodiment, system 10 increases thermal and overall efficiency of a portable fuel cell system by using waste heat in the system to heat incoming reactants such as an incoming fuel or air. To this end, the embodiment in FIG. 6B includes heat exchanger, or recuperator, 42.

Heat exchanger 42 transfers heat from fuel cell system 10 to the inlet fuel 17 before the methanol reaches fuel processor 15. This increases thermal efficiency for system 10 by preheating the incoming fuel (to reduce heating of the fuel in heater 30) and reuses heat that would otherwise be expended from the system. While system 10 shows heat exchanger 42 heating methanol in line 29 that carries fuel 17 to the boiler 34 and reformer 32, it is understood that heat exchanger 42 may be used to heat methanol in line 27 that carries fuel 17 to burner 30.

In addition to the components shown in shown in FIG. 6B, system 10 may also include other elements such as electronic controls, additional pumps and valves, added system sensors, manifolds, heat exchangers and electrical interconnects useful for carrying out functionality of a fuel cell system 10 that are known to one of skill in the art and omitted for sake of brevity. FIG. 6B shows one specific plumbing arrangement for a fuel cell system; other plumbing arrangements are suitable for use herein. For example, the heat transfer appendages 46, a heat exchanger and dewar 36 need not be included. Other alterations to system 10 are permissible, as one of skill in the art will appreciate.

System 10 generates direct current (DC) voltage, and is suitable for use in a wide variety of portable applications. For example, electrical energy generated by fuel cell 20 may power a notebook computer 11 or a portable electrical generator 11 carried by military personnel.

In one embodiment, system 10 provides portable, or ‘small’, fuel cell systems that are configured to output less than 200 watts of power (net or total). Fuel cell systems of this size are commonly referred to as ‘micro fuel cell systems’ and are well suited for use with portable electronics devices. In one embodiment, the fuel cell is configured to generate from about 1 milliwatt to about 200 Watts. In another embodiment, the fuel cell generates from about 5 Watts to about 60 Watts. Fuel cell system 10 may be a stand-alone system, which is a single package 11 that produces power as long as it has access to a) oxygen and b) hydrogen or a fuel such as a hydrocarbon fuel. One specific portable fuel cell package produces about 20 Watts or about 45 Watts, depending on the number of cells in a stack for fuel cell 20.

While the embodiment discussed herein mainly been discussed so far with respect to a reformed methanol fuel cell (RMFC), other types of fuel cells may also apply, such as a solid oxide fuel cell (SOFC), a phosphoric acid fuel cell (PAFC), a direct methanol fuel cell (DMFC), or a direct ethanol fuel cell (DEFC). In this case, fuel cell 20 includes components specific to these architectures, as one of skill in the art will appreciate. A DMFC or DEFC receives and processes a fuel. More specifically, a DMFC or DEFC receives liquid methanol or ethanol, respectively, channels the fuel into the fuel cell stack 60 and processes the liquid fuel to separate hydrogen for electrical energy generation. For a DMFC, shared flow fields 208 in the flow field plates 202 distribute liquid methanol instead of hydrogen. Hydrogen catalyst 126 described above would then comprise a suitable anode catalyst for separating hydrogen from methanol. Oxygen catalyst 128 would comprise a suitable cathode catalyst for processing oxygen or another suitable oxidant used in the DMFC, such as peroxide. In general, hydrogen catalyst 126 is also commonly referred to as an anode catalyst in other fuel cell architectures and may comprise any suitable catalyst that removes hydrogen for electrical energy generation in a fuel cell, such as directly from the fuel as in a DMFC. In general, oxygen catalyst 128 may include any catalyst that processes an oxidant in used in fuel cell 20. The oxidant may include any liquid or gas that oxidizes the fuel and is not limited to oxygen gas as described above. An SOFC, PAFC, or molten carbonate fuel cell (MCFC) may also benefit from inventions described herein, for example. In this case, fuel cell 20 comprises an anode catalyst 126, cathode catalyst 128, anode fuel and oxidant according to a specific SOFC, PAFC, or MCFC design.

While embodiments and applications of this invention have been shown and described, it would be apparent to those skilled in the art having the benefit of this disclosure that many more modifications than mentioned above are possible without departing from the inventive concepts herein.

What is claimed is:

1. A fuel cell stack for use in a fuel cell, comprising:
a plurality of cathode flow field plates having a first plurality of through-cuts to form a first plurality of shared flow fields to receive a first reactant gas flow;
a plurality of anode flow field plates having a second plurality of through-cuts to form a second plurality of shared flow fields to receive a second reactant gas flow; and
a plurality of membrane electrode assembly (MEA) layers, each of the MEA layers disposed between one of the plurality of cathode flow field plates and one of the plurality of anode flow field plates, each of the MEA layers including an anode electrode a cathode electrode;
wherein adjacent cathode electrodes of adjacent MEA layers share the first plurality of shared flow fields; and
wherein adjacent anode electrodes of adjacent MEA layers share the second plurality of shared flow fields.

2. The fuel cell stack of claim 1, further comprising a plurality of current connectors, each plurality of current connectors having a first end disposed externally on one side of the cathode flow field plate and a second end disposed externally on one side of one of the anode flow field plate to electrically connect the cathode flow field plate to the anode flow field plate.

3. The fuel cell stack of claim 2, wherein the plurality of current connectors comprise a flexible conducting material.

4. The fuel cell stack of claim 2, wherein the plurality of cathode flow field plates, the plurality of anode flow field plates, and the plurality of current connectors form a single integrally formed fuel cell stack assembly.

5. The fuel cell stack of claim 2, further comprising a metal layer surrounding the plurality of current connectors.

6. The fuel cell stack of claim 5, further comprising a thermal catalyst disposed on the metal layer.

7. The fuel cell stack of claim 1, wherein the plurality of MEA layers further comprise an ion conductive membrane disposed between the anode electrode and the cathode electrode to electrically isolate the anode electrode from the cathode electrode.

8. The fuel cell stack of claim 1, wherein the first reactant gas flow is air and the second reactant gas flow is hydrogen.

9. The fuel cell stack of claim 1, wherein the plurality of cathode flow field plates further comprise:
a first conductive plate to receive a first current flow generated from the cathode electrode from one of the plurality of MEA layers;
a second conductive plate to receive a second current flow generated from the cathode electrode from an adjacent MEA layer; and
a dielectric layer disposed between the first conductive plate and the second conductive plate to electrically isolate the first conductive plate from the second conductive plate.

10. The fuel cell stack of claim 1, wherein the plurality of anode flow field plates further comprise:
a first conductive plate to receive a first current flow generated from the anode electrode from one of the plurality of MEA layers;
a second conductive plate to receive a second current flow generated from the anode electrode from an adjacent MEA layer; and
a dielectric layer disposed between the first conductive plate and the second conductive plate to electrically isolate the first conductive plate from the second conductive plate.

11. The fuel cell stack of claim 1, wherein the plurality of MEA layers further comprise:
a first gas diffusion layer disposed on the anode electrode; and
a second gas diffusion layer disposed on the cathode electrode.

12. The fuel cell stack of claim 11, wherein the plurality of cathode flow field plates further comprise:
a top frame disposed on a top outer edge to form a top socket to receive the second gas diffusion layer from one of the plurality of MEA layers;
a bottom frame disposed on a bottom outer edge to form a bottom socket to receive the second gas diffusion layer from an adjacent MEA layer.

13. A fuel cell stack for use in a fuel cell, comprising:
a first MEA layer including a first anode electrode and a first cathode electrode;
a second MEA layer including a second anode electrode and a second cathode electrode;
an anode flow field plate disposed between the first MEA layer and the second MEA layer, the anode flow field plate having a plurality of through-cuts to form a plurality of shared anode flow fields to receive a first reactant gas flow,
wherein the first anode electrode and the second anode electrode receive the first reactant gas flow from the plurality of shared anode flow fields;
a third MEA layer including a third anode electrode and a third cathode electrode;
a cathode flow field plate disposed between the second MEA layer and the third MEA layer, the cathode flow field plate having a plurality of through-cuts to form a plurality of shared cathode flow fields to receive a second reactant gas flow,
wherein the second cathode electrode and the third cathode electrode receive the second reactant gas flow from the plurality of shared cathode flow fields.

14. The fuel cell stack of claim 13, wherein the anode flow field further comprises:
a first conductive plate to receive a first current flow generated from the first anode electrode;
a second conductive plate to receive a second current flow generated from the second anode electrode;
a dielectric layer disposed between the first conductive plate and the second conductive plate to electrically isolate the first conductive from the second conductive plate.

15. The fuel cell stack of claim 13, wherein the cathode flow field further comprises:
a first conductive plate to receive a first current flow generated from the second cathode electrode;
a second conductive plate to receive a second current flow generated from the third cathode electrode;
a dielectric layer disposed between the first conductive plate and the second conductive plate to electrically isolate the first conductive plate from the second conductive plate.

16. The fuel cell stack of claim 13, wherein the anode flow field plate further comprises:
a top frame disposed on a top outer edge of the flow field plate to form a socket to receive a first gas diffusion layer disposed on the first anode electrode; and
a bottom frame disposed on a bottom outer edge of the flow field plate to form a socket to receive a second gas diffusion layer disposed on the second anode electrode.

17. The fuel cell stack of claim 13, wherein the cathode flow field plate further comprises:
a top frame disposed on a top outer edge of the flow field plate to form a socket to receive a third gas diffusion layer disposed on the second cathode electrode; and
a bottom frame disposed on a bottom outer edge of the flow field plate to form a socket to receive the fourth gas diffusion layer disposed on the third cathode electrode.

18. The fuel cells stack of claim 13, wherein the first reactant gas flow is air and the second reactant gas flow is hydrogen.

19. The fuel cell stack of claim 13, further comprising a current connector having a first end disposed on a first side of the anode flow field plate and a second end disposed on a first side of the cathode flow field plate to electrically connect the anode flow field plate to the cathode flow field plate.

20. The fuel cell stack of claim 19, wherein the current connector comprises a flexible conducting material.

21. The fuel cell stack of claim 19, further comprising a metal layer surrounding the current connector.

22. The fuel cell stack of claim 21, further comprising a thermal catalyst disposed on the metal layer.

23. A method for manufacturing a fuel cell stack, comprising:
forming a plurality of through-cut cathode openings on a first pair of cathode conductive plates;
forming a plurality of through-cut openings on a first dielectric plate;
forming a plurality of through-cut anode openings on a first pair of anode conductive plates;
forming a plurality of through-cut openings on a second dielectric plate;
joining the first dielectric plate between the first pair of cathode conductive plates to form a first cathode flow field plate, wherein the plurality of through-cut openings on the first dielectric plate align with the plurality of through-cut cathode openings;
joining the second dielectric plate between the first pair of anode conductive plates to form a first anode flow field plate, wherein the plurality of through-cut openings on the second dielectric plate align with the plurality of through-cut anode openings;
coupling a first end of a first current connector to a first side of the first cathode flow field plate and a second end of the first current connector to a first side of the first anode flow field plate; and
inserting a first membrane electrode layer (MEA) between the first cathode flow field plate and the first anode flow field plate,
wherein the first cathode flow field plate is adjacent a cathode electrode of the MEA such that the cathode electrodes of adjacent MEAs share the through-cut cathode openings, and
wherein the first anode flow field plate is adjacent the anode electrode of the MEA such that anode electrodes of adjacent MEAs share the anode through-cut anode openings.

24. The method of claim 23, further comprising:
forming a second plurality of through-cut cathode openings on a second pair of cathode conductive plates;
forming a plurality of through-cut openings on a third dielectric plate;
aligning the plurality of through-cut openings on the third dielectric plate with the second plurality of through-cut cathode openings;
joining the third dielectric plate between the second pair of cathode conductive plates to form a second cathode flow field plate; and
coupling a first end of a second current connector to the second side of the first anode flow field plate and the second end of the second current connector to a first side of the second cathode flow field plate.

25. The method of claim 23, wherein the coupling further comprises bending the first current connector.

26. The method of claim 24, wherein the coupling further comprises bending the second current connector.

27. The method of claim 23, further comprising coupling a top frame to a top surface of the first cathode fluid flow plate to form a top cathode seat and a bottom frame to a bottom surface of the first cathode fluid flow plate to form a bottom cathode seat.

28. The method of claim 28, further comprising inserting a first cathode gas diffusion layer in the top cathode seat and a second cathode gas diffusion layer in the bottom cathode seat.

29. The method of claim 23, further comprising coupling a top frame to a top surface of the first anode fluid flow plate to form a top anode seat and a bottom frame to a bottom surface of the first anode fluid flow plate to form a bottom anode seat.

30. The method of claim 29, further comprising inserting a first anode gas diffusion layer in the top anode seat and a second anode gas diffusion layer in the bottom anode seat.

31. The method of claim 23, further comprising depositing a metal layer on the current connector.

32. The method of claim 31, further comprising depositing a catalyst on the metal layer.
